(19) United States
(12) Patent Application Publication
(10) Pub. No.: US 2009/0110905 A1
(43) Pub. Date: Apr. 30, 2009

(54) System and Method for Expanding Plastic and Rubber Using Solid Carbon Dioxide, and Expanded Plastic or Rubber Material Made Thereby

(76) Inventor: Yuri Starostenko, Nassau (BS)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/252,405

(22) Filed: Oct. 16, 2008

Related U.S. Application Data
(60) Provisional application No. 60/980,223, filed on Oct. 16, 2007.
(60) Provisional application No. 61/105,765, filed on Oct. 15, 2008.

(51) Int. Cl. B32B 3/26; B29C 44/04; B29C 47/12

(52) U.S. Cl. 428/305.5; 264/51; 425/4 R

(57) ABSTRACT

A system and method for expanding a thermoplastic material includes extruding a melted thermoplastic material through an extruder, continuously introducing a solid carbon dioxide material under pressure into the melted thermoplastic material in the extruder, foaming the melted thermoplastic material by changing the solid carbon dioxide material to gaseous carbon dioxide and allowing the gaseous carbon dioxide to mechanically mix with and foam the melted thermoplastic material, and collecting the foamed, extruded thermoplastic material. A foamed, extruded thermoplastic material is produced by the method and system.

### CROSS-REFERENCE TO RELATED APPLICATIONS

This application is a nonprovisional application and claims benefit of the filing of prior provisional application Nos. 60/980,223, filed Oct. 16, 2007, the contents of which are incorporated herein in their entireties, and 61/105,765, filed Oct. 15, 2008, the contents of which are incorporated herein in their entireties.

### BACKGROUND OF THE INVENTION

The present invention relates to a system and method for expanding plastic and rubber using solid carbon dioxide, and to an expanded plastic or rubber material made thereby.

Various materials are known to be materials that can be expanded. Such materials include material having molecules with large molecular mass composed of repeating units connected by covalent chemical bonds. Plastics such as polystyrene (PS), polyvinyl chloride (PVC) and rubber are usually considered such materials.

Expanded materials can be synthesized in an “open cell” form, in which the foam bubbles are interconnected, as in an absorbent sponge. The materials expanded in this manner are sometimes referred to as being “foamed” (for example, “foamed rubber”) and can be formed by a process of formation of cells such as chemical foam production.

Other expanded materials can be produced in “closed cell,” in which all the bubbles are distinct, like tiny balloons. The materials expanded in this manner are sometimes referred to as “extruded” (for example, “extruded polystyrene”) and can be formed by a method of manufacture such as non-chemical foam production.

Open cell foamed materials should not be confused with closed cell or extruded expanded materials. Extruded expanded materials have advantageous properties such as high moisture resistance, high R-value of insulation, light weight, buoyancy, durability and brittle resistance. Extruded expanded materials can be used for building materials (including insulated sheathing and house wrap), pipe insulation and floral and craft products. Extruded expanded materials can also be used underneath roads and other structures to prevent soil disturbances due to seasonal freeze-thaw cycles. Coffee cups, coolers and packaging material can also be made of extruded expanded materials and are typically white in color and are made of extruded polystyrene beads.

In the early 1940s, The Dow Chemical Company began using a process for extruding polystyrene to achieve “closed cell” foam that resists moisture. The process includes extruding of a polymer by double-screw extruder with lateral injection of an expanding (foaming) agent or blend of them under high pressure, i.e., 80-120 bar.

As foaming agents, gases exclusively in liquefied substances can be used. Examples include butanes, isobutene, hydro-chlorofluoro-carbons (HCFC-R22, HCFC-R407), chlorofluoro-carbons (HCF-142b, HCF-365mfc, HFC-134a), new generation gases B152, B152A, liquid carbon dioxide (LCO2), blend of LCO2 and 2-ethyl hexanol (2-EH), Enovate™ 3000, ethers and others. Liquid carbon dioxide (LCO2) has already often been proposed as an expanding co-agent on the grounds of environmental acceptability and industrial hygiene.

U.S. Pat. Nos. 5,250,577 and 5,266,605 to Welsh disclose a process for producing a thermoplastic foam comprising the steps of (a) melting a styrenic polymer, (b) continuously directly introducing into the melted styrenic polymer a blowing agent consisting essentially of carbon dioxide in an amount of about 0.5 to about 6 weight percent based on the weight of the styrenic polymer, (c) mixing intimately the styrenic polymer and the carbon dioxide, and (d) extruding and foaming the mixture at a die temperature able to maintain a foamable mixture of the molten styrenic polymer and the carbon dioxide but below about 150.degree.C. into a region of lower pressure to form thermoplastic foam having cell sizes in all direction which are less than one millimeter and a foam sheet thickness which is less than about 0.5 inch. It is disclosed that the carbon dioxide is preferably added to a polymer melt in a liquid form, although use of the carbon dioxide in the gaseous form would also be acceptable.

The latest traditional extruding methods of expansion of plastics allow use of blend of liquid carbon dioxide (LCO2) and 2-ethyl hexanol (2-EH) (or ethers and others which are usually expensive) from 12.0 to 15.0% based upon the weight of the melt mixture.

However, it would be desirable to provide a system and method for expanding plastic and rubber that operates at reduced injection pressures and/or allows for an increased degree of expansion, and to provide an expanded plastic or rubber material made thereby.

### SUMMARY OF THE INVENTION

A method for expanding a thermoplastic material includes extruding a melted thermoplastic material through an extruder, continuously introducing a solid carbon dioxide material under pressure into the melted thermoplastic material in the extruder, foaming the melted thermoplastic material by changing the solid carbon dioxide material to gaseous carbon dioxide and allowing the gaseous carbon dioxide to mechanically mix with and foam the melted thermoplastic material, and collecting the foamed, extruded thermoplastic material.

A system for expanding a thermoplastic material includes an extruder for extruding a melted thermoplastic material, an intruder for introducing a solid carbon dioxide material under pressure into the melted thermoplastic material in the extruder, a heater of heating the thermoplastic material and for changing the solid carbon dioxide material to gaseous carbon dioxide and allowing the gaseous carbon dioxide to mechanically mix with and foam the melted thermoplastic material, and a slot die though which the foamed, extruded thermoplastic material exits the extruder.

A foamed, extruded thermoplastic material is produced by the method and system.

### BRIEF DESCRIPTION OF THE DRAWINGS

FIG. 1 is a schematic view showing a portion of a production line for producing a foamed, extruded thermoplastic material according to one embodiment of the present invention.

FIG. 2 is a schematic view showing an example of an intruder used in the method and system of the present invention.

FIG. 3 is a schematic view showing an example of an outlet of an intruder used in the method and system of the present invention without a deflector.

### DETAILED DESCRIPTION OF THE INVENTION

The present invention relates to a method for expanding a thermoplastic material includes extruding a melted thermoplastic material through an extruder, continuously introducing a solid carbon dioxide material under pressure into the melted thermoplastic material in the extruder, foaming the melted thermoplastic material by changing the solid carbon dioxide material to gaseous carbon dioxide and allowing the gaseous carbon dioxide to mechanically mix with and foam the melted thermoplastic material, and collecting the foamed, extruded thermoplastic material.

The present invention also relates to a system for expanding a thermoplastic material includes an extruder for extruding a melted thermoplastic material, an intruder for introducing a solid carbon dioxide material under pressure into the melted thermoplastic material in the extruder, a heater of heating the thermoplastic material and for changing the solid carbon dioxide material to gaseous carbon dioxide and allowing the gaseous carbon dioxide to mechanically mix with and foam the melted thermoplastic material, and a slot die though which the foamed, extruded thermoplastic material exits the extruder. The thermoplastic material used in the present invention can be any thermoplastic material that can be extruded and expanded, including, but not limited to acrylonitrile butadiene styrene (ABS), acrylic (PMMA), celluloid, cellulose acetate, ethylene-vinyl acetate (EVA), ethylene vinyl alcohol (EVOH), fluoroplastics (PTFE, alongside with FEP, PFA, CTFE, ECTFE, ETFE), ionomers, Kydex™ (an acrylic/PVC alloy), liquid crystal polymer (LCP), polyacetal (POM or Acetal), polyacrylates (acrylic), polyacrylonitrile (PAN or acrylonitrile), polyamide (PA or nylon), polyamide-imide (PAI), polyaryletherketone (PAEK or ketone), polybutadiene (PBD), polybutylene (PB), polybutylene terephthalate (PBT), polycaprolactone (PCL), polychlorotrifluoroethylene (PCTFE), polyethylene terephthalate (PET), polycyclohexylene dimethylene terephthalate (PCT), polycarbonate (PC), polyhydroxyalkanoates (PHAs), polyketone (PK), polyester, polyethylene (PE), polyetheretherketone (PEEK), polyetherimide (PEI), polyethersulfone (PES), polysulfone, polyethylenechlorinates (PEC), polyimide (PI), polylactic acid (PLA), polymethylpentene (PMP), polyphenylene oxide (PPO), polyphenylene sulfide (PPS), polyphthalamide (PPA), polypropylene (PP), polystyrene (PS), polysulfone (PSU), olytrimethylene terephthalate (PTT), polyurethane (PU), polyvinyl acetate (PVA), polyvinyl chloride (PVC), polyvinylidene chloride (PVDC), rubber, spectralon, and styrene-acrylonitrile (SAN). Preferably, the thermoplastic material is selected form the group consisting of polystyrene, polyethylene, polypropylene and thermoplastic rubbers. More preferably, the thermoplastic material is polystyrene.

The present invention provides a method for the production of foams from thermoplastic polymers and rubbers, e.g., polystyrene, using solid carbon dioxide (SCO2) as an expanding agent, by intruding it into the melt extruder with a mixture of plastic (rubber) and additives, expanding the melt mixture and physical curing. The SCO2 can be the sole expanding agent.

Carbon dioxide is a colorless gas and natural by product of breathing. Its density at 25° C. is 1.98 kg m³ (0.123 lbs/f³), about 1.65 times that of air. This means that CO₂ gas displaces oxygen (the CO₂ will sink to the floor and the oxygen will rise above it). As it is fully oxidized, it is not very reactive and, in particular, not flammable.

At temperatures below −78° C., carbon dioxide changes directly from a gas to a white solid called commonly “dry ice” through a process called deposition. Liquid carbon dioxide forms only at pressures above 5.1 atm; at atmospheric pressure, it passes directly between the solid phase and the gaseous phase in a process called sublimation.

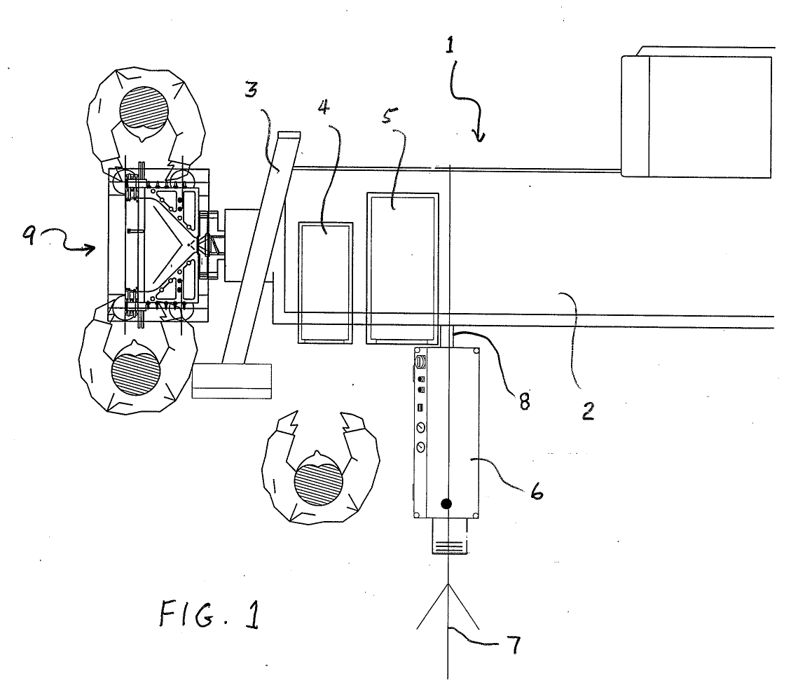

In one embodiment of the present invention, the solid carbon dioxide (SCO2) can be produced from liquid carbon dioxide (LCO2) stored in a tank. The LCO2 that has been pressurized is allowed to expand into the natural atmosphere. This causes the LCO2 to expand into both a gas vapor and solid snow. The snow is then both compressed and intruded into the melt extruder. FIG. 1 is a schematic view showing a portion of a production line for producing a foamed, extruded thermoplastic material according to one embodiment of the present invention. Details concerning one embodiment of the entire production line are shown and described in U.S. provisional application No. 61/105,765, filed Oct. 15, 2008, the contents of which are incorporated herein in their entireties. As shown in FIG. 1, a production line 1 for producing a foamed, extruded thermoplastic material includes a melt extruder 2 as is known in the art. For example, the melt extruder can be a standard single-screw extruder with screw diameter of 135 mm, although other diameters can be used as would be known by those skilled in the art. The melt extruder has a slot die (extrusion head) 9 through which expanded (foamed) thermoplastic material exits and an extruder gauge system 3 for defining the width of the slot die 9. Thermo-regulating units 4, 5 are provided for thermal control of different sections of the slot die.

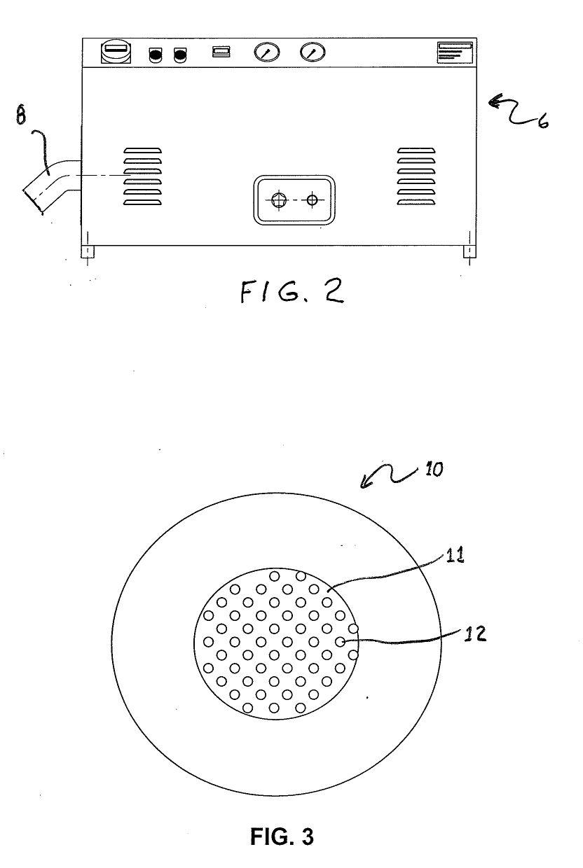

One or more high-density rods of SCO2 can be created by a pelletizer or intruder 6 that intrudes a homogenous SCO2 under pressure and with speed controlled by a dosing system. As noted above, the solid carbon dioxide (SCO2) can be produced from liquid carbon dioxide (LCO2) stored in a tank. The LCO2 that has been pressurized is allowed to expand into the natural atmosphere. This causes the LCO2 to expand into both a gas vapor and solid snow. The snow is then both compressed and intruded into the melt extruder by the intruder 6. The intruder 6 forms a high-density firm cylindrical rod that is intruded into the melt extruder 2 with foamable polymeric mass through deflector 8 under mechanical pressure created by a mechanical pressure element such as a screw in the intruder 6. See, also, FIG. 2.

In one embodiment, shown in FIG. 3, which is a schematic view showing an example of an outlet of an intruder used in the method and system of the present invention without the deflector 8, a plurality of high-density SCO2 rods can be intruded off by the intruder 8 through a die 11 having a plurality of holes 12. The size, shape, number and layout of the holes 12 can be varied. The individual rods are united in this embodiment in the deflector 8 to form one firm single rod.

According to one embodiment of the present invention, the SCO2 rod is intruded laterally (with respect to the extrusion direction) into the extruder 2, as shown in FIG. 1. Once in the extruder, the SCO2 rod is cut by the screw of the extruder.

For the favorable formation of “closed cell” bubbles and of foam according to the invention, it has been found that a polystyrene foam matrix having a density of 63-70 kg/m3 (which is commonly use in the industry) can be successfully produced with a charge of from 0.2 to 0.3% by weight of SCO2 based upon the weight of the melt mixture. Preferably, the diameter of the rod is 0.00342×diameter of extruder's screw.

Thus, one aspect of the present invention relates to using SCO2 in form of a firm endless rod as a foaming (blowing) agent in a continuous extrusion process. The process occurs under a pressure of, e.g., 2-12 bar and under constant heating at temperatures of, e.g., 110-250° C. In the process, a mechanical mixing of the foaming agent in its rigid stage with foamable compositions occurs only (i.e., without chemical reaction).

Without being bound by any theory, applicant believes that the use of a firm endless rod of SCO2 is so efficient for the following reasons. Extremely rapid heat transfer between cuts from the intruded SCO2 firm endless rod (the extruder's screw cuts the rod) and polymeric melt mass cause instantaneous sublimation of the SCO2 into gas. The gas expands to nearly 800 times the volume of the cut-off particle in a few milliseconds in what is effectively a “micro-explosion” at the space of impact.

Instantaneous sublimation (phase change from solid to gas) of SCO2 cut-off particles upon impact absorbs maximum heat from the polymeric mass. The very rapid transfer of heat into the cut off particle from the melted foamable mass creates an extremely large temperature differential between successive micro-layers within the mass. This sharp thermal gradient produces localized high shear stresses between the micro-layers. The high shear produced over a very brief expanse of time causes rapid micro-crack propagation between the layers. Under instant mechanical pressure created by screw of the extruder, the space of impact moves through the high temperature foamable mass leading to a cracking of all internal structure and permitting to absorb the gas created by the sublimation of the carbon dioxide. Thus, the formation of closed cells or the foaming occurs.

The foaming itself is a frequency of instant events (blows) of the foaming agent at equal time intervals (1.5-2.5 sec.). Each blow represents the foaming agent's own property variation from solid to gaseous. SCO2 in normal room ambient is a subject of constant depletion. In closed ambient or “under pressure” and under high temperature, the depletion becomes almost instantaneous. Each piece of SCO2 rod intruded in the extruder and cut off by the screw almost instantaneously changes from solid to gaseous, similar to a “blow.”

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

I claim:

1. A method for expanding a thermoplastic material, comprising:
extruding a melted thermoplastic material through an extruder;
continuously introducing a solid carbon dioxide material under pressure into the melted thermoplastic material in the extruder;
foaming the melted thermoplastic material by changing the solid carbon dioxide material to gaseous carbon dioxide and allowing the gaseous carbon dioxide to mechanically mix with and foam the melted thermoplastic material; and
collecting the foamed, extruded thermoplastic material.

2. The method according to claim 1, wherein the thermoplastic material is selected form the group consisting of polystyrene, polyethylene, polypropylene and thermoplastic rubbers.

3. The method according to claim 1, wherein the solid carbon dioxide material is continuously introduced under pressure into the melted thermoplastic material in the extruder under a pressure of 2-12 bar.

4. The method according to claim 1, wherein the melted thermoplastic material and the carbon dioxide material is heated in the extruder to a temperature in the range of 110-250° C.

5. The method according to claim 1, wherein the solid carbon dioxide material is cut into pieces by a screw of the extruder cut pieces solid carbon dioxide material absorb heat from the melted thermoplastic material to change the cut pieces of solid carbon dioxide material to gaseous carbon dioxide.

6. The foamed, extruded thermoplastic material produced by the method of claim 1.

7. A system for expanding a thermoplastic material, comprising:
an extruder for extruding a melted thermoplastic material;
an intruder for introducing a solid carbon dioxide material under pressure into the melted thermoplastic material in the extruder;
a heater of heating the thermoplastic material and for changing the solid carbon dioxide material to gaseous carbon dioxide and allowing the gaseous carbon dioxide to mechanically mix with and foam the melted thermoplastic material; and
a slot die though which the foamed, extruded thermoplastic material exits the extruder.
